(19) United States
(12) Patent Application Publication
(10) Pub. No.: US 2013/0124557 A1
(43) Pub. Date: May 16, 2013

(54) SYSTEMS AND METHODS FOR USER CONFIGURABLE RECOMMENDATION SYSTEMS

(71) Applicant: Sweetlabs, Inc., San Diego, CA (US)

(72) Inventors: James A. Goode, San Diego, CA (US); Alastair Mayo, San Diego, CA (US)

(73) Assignee: SWEETLABS, INC., San Diego, CA (US)

(21) Appl. No.: 13/677,298

(22) Filed: Nov. 14, 2012

Related U.S. Application Data
(60) Provisional application No. 61/559,638, filed on Nov. 14, 2011.

(51) Int. Cl. G06F 17/30

(52) U.S. Cl. CPC G06F 17/30477
USPC 707/769

(57) ABSTRACT

Systems and methods in accordance with embodiments of the invention include user configurable recommendation systems that enable a user to modify the presentation of recommendations in a user interface. One embodiment includes at least one recommendation module running on a user device configured to present recommendations in a user interface of a user device based upon a command generated by a recommendation module; a command history database configured to store a history of commands; wherein at least one recommendation module is a requesting recommendation module configured to: query the command history database for information on a current command concerning display of recommendations; receive the information on the current command concerning display of recommendations on the requesting recommendation module's user interface that causes the requesting recommendation module to present a notification of the current command along with a notification of commands that may be generated.

### CROSS-REFERENCE TO RELATED RECOMMENDATION MODULES

The current application claims priority to U.S. patent application No. 61/559,638, filed Nov. 14, 2011, the disclosure of which is incorporated herein by reference in its entirety.

### FIELD OF THE INVENTION

The present invention relates generally to recommendation systems and more specifically to configuring recommendations displayed in the user interface of a recommendation module.

### BACKGROUND OF THE INVENTION

Recommendations, such as advertisements, offers or promotions, can be used to generate revenue due to the exposure of the recommendations to a target audience. Potential revenue generation from recommendations is based on various performance factors such as ratio of offers accepted to recommendations presented, total number of recommendations presented, geographic location of audience, and other similar data points. Revenue generation from recommendations is frequently plagued by very low acceptance rates. Given small acceptance statistics, a very large number of recommendations presentations must be made in order to generate meaningful revenue. In addition, fairly complex business agreements must be forged in order to take benefit from these types of revenue sources. Many smaller organizations do not have the proper types of human resources or the experience needed to negotiate these types of agreements. While many different types of potential offers exist it is often hard to predict with which offer(s) it will be profitable to engage. Complexity in integrating recommendations with existing recommendation modules, costs in distributing software, development expenses for gathering data, and difficulty with targeting offers often precludes the use of more than one recommendation deal by a specific organization.

### SUMMARY OF THE INVENTION

Turning now to the drawings, user configurable recommendation systems that enable a user to modify the presentation of recommendations in a user interface in accordance with embodiments of the invention are illustrated. One embodiment includes a user configurable recommendation system including: at least one recommendation module running on a user device configured to present recommendations in a user interface of a user device based upon at least one command generated by at least one recommendation module; a command history database accessible by at least one recommendation module and configured to store a history of commands generated by at least one recommendation module; where at least one recommendation module is a requesting recommendation module configured to: send a request to query the command history database for information on a current command concerning display of recommendations on the requesting recommendation module's user interface; receive the information on the current command concerning display of recommendations on the requesting recommendation module's user interface that causes the requesting recommendation module to present a notification of the current command along with a notification of commands that may be generated in the user interface of the requesting recommendation module.

In a further embodiment, the command history database is accessible through an integrating application that communicates with at least one recommendation module.

In another embodiment, each command concerns whether recommendations are to be presented by the requesting recommendation module in the user interface of the user device.

In a still further embodiment, the requesting recommendation module presents a notification of the current command along with a notification of commands that may be generated as text displayed in the user interface by requesting recommendation module.

In still another embodiment, the text is displayed as an active text field.

In a yet further embodiment, the active text field is implemented as a Flash recommendation module that is capable of running Small Web Format files.

In yet another embodiment, the requesting recommendation module presents a notification of the current command along with a notification of commands that may be generated graphically as a picture displayed in the user interface of the requesting recommendation module.

In a further embodiment again, the user device is configured to execute an installation package including a payload application installer, a payload application and the requesting recommendation module, where the execution of the installation package causes the payload application to be installed on the user device and triggers execution of the requesting recommendation module, which is configured to automatically collect information stored on the user device during the installation of the payload application and to forward the collected information to a recommendation management server as the installation package performs the installation of the payload application; the recommendation management server is configured to send a list of recommendations to the requesting recommendation module, where the recommendation management server selects the recommendations to include in the list of recommendations based upon the information collected during the installation of the payload application that configures the requesting recommendation module to select recommendations from the list of recommendations and request resources for the recommendation module to present the selected recommendations in a user interface of the user device from a recommendation content server; and the requesting recommendation module is configured to display the particular recommendations from resources received from the recommendation content server during the installation of the payload application.

In another embodiment again, the requesting recommendation module is bundled in the installation package and the payload application installer activates the requesting recommendation module via an adaptor.

In a further additional embodiment, the recommendation content server and the recommendation management server are consolidated within a single server.

Another additional embodiment includes a method of managing recommendations in a user configurable recommendation management system including at least one recommendation module running on a user device configured to present recommendations in a user interface of a user device based upon at least one command generated by at least one recommendation module, including: sending a request using a requesting recommendation module to query a command history database for information on a current command concerning display of recommendations on a requesting recommendation module's user interface, where: the command history database is accessible by at least one recommendation module and configured to store a history of commands generated by at least one recommendation module; and at least one recommendation is the requesting recommendation module; and receiving the information on the current command concerning display of recommendations on the requesting recommendation module's user interface using the requesting recommendation module that causes the requesting recommendation module to present a notification of the current command along with a notification of commands that may be generated in the user interface of the requesting recommendation module.

In a still yet further embodiment, the command history database is accessible through an integrating application that communicates with at least one recommendation module.

In still yet another embodiment, each command concerns whether recommendations are to be presented by the requesting recommendation module in the user interface of the user device.

In a still further embodiment again, the requesting recommendation module presents a notification of the current command along with a notification of commands that may be generated as text displayed in the user interface by requesting recommendation module.

In still another embodiment again, the text is displayed as an active text field.

In a still further additional embodiment, the active text field is implemented as a Flash application that is capable of running Small Web Format files.

In still another additional embodiment, the requesting recommendation module presents a notification of the current command along with a notification of commands that may be generated graphically as a picture displayed in the user interface of the requesting recommendation module.

In a yet further embodiment again, the user device is configured to execute an installation package including a payload application installer, a payload application and the requesting recommendation module, where the execution of the installation package causes the payload application to be installed on the user device and triggers execution of the requesting recommendation module, which is configured to automatically collect information stored on the user device during the installation of the payload application and to forward the collected information to a recommendation management server as the installation package performs the installation of the payload application; the recommendation management server is configured to send a list of recommendations to the requesting recommendation module, where the recommendation management server selects the recommendations to include in the list of recommendations based upon the information collected during the installation of the payload application that configures the requesting recommendation module to select recommendations from the list of recommendations and request resources for the recommendation module to present the selected recommendations in a user interface of the user device from a recommendation content server; and the requesting recommendation module is configured to display the particular recommendations from resources received from the recommendation content server during the installation of the payload application.

In yet another embodiment again, the requesting recommendation module is bundled in the installation package and the payload application installer activates the requesting recommendation module via an adaptor.

A yet further additional embodiment includes a user configurable recommendation system including: a recommendation management server configured to send instructions to a recommendation content server that manages recommendations sent from a recommendation content server to a user device for presentation in a user interface of at least one recommendation module running on the user device based upon at least one command sent from at least one recommendation module to the recommendation management server; a command history database accessible by the recommendation management server and configured to store a history of commands received by the recommendation management server; where the recommendation management server is configured to: receive a request from a requesting recommendation module that causes the recommendation management server to query the command history database for information on a current command concerning display of recommendations on the requesting recommendation module's user interface sent from the requesting recommendation module to the recommendation management server; return the information on the current command concerning display of recommendations on requesting recommendation module's user interface to the requesting recommendation module that causes the requesting recommendation module to present a notification of the current command along with a notification of commands that may be sent to the recommendation management server in the user interface of the requesting recommendation module.

### BRIEF DESCRIPTION OF THE DRAWINGS

FIG. 1 is a system diagram of a user configurable recommendation system in accordance with an embodiment of the invention.

FIG. 2 illustrates a flow chart of a process for sending instructions to a recommendation content server in accordance with an embodiment of the invention.

FIG. 3 illustrates a flowchart of a process of a content management server returning a current command in accordance with an embodiment of the invention.

FIG. 4 is a screen shot of a user interface including a recommendation configurability mechanism that enables a user to skip the display of all future recommendations in accordance with an embodiment of the invention.

FIG. 5 is a screen shot of a user interface with a recommendation configurability mechanism that includes the ability to send a command to no longer receive recommendations in accordance with an embodiment of the invention.

FIG. 6 is a screen shot of a user interface that enables a user to send a command to display recommendations received from a recommendation content server in accordance with an embodiment of the invention.

FIG. 7 illustrates a flowchart of a process of presenting targeted recommendations in accordance with an embodiment of the invention.

### DETAILED DESCRIPTION OF THE INVENTION

Turning now to the drawings, user configurable recommendation systems that enable a user to modify the presentation of recommendations in a user interface in accordance with embodiments of the invention are illustrated. In many embodiments, a user configurable recommendation system presents recommendations via a user interface of a user device, where the resources to present recommendations are provided by a recommendation content server according to instructions from a recommendation management server or a recommendation module. The instructions of the recommendation management server or recommendation module are based upon commands sent to the recommendation management server or received by the recommendation module from the user device, where the commands are generated from a user's interaction with the user interface of the user device. In numerous embodiments, a command may exist by default and is not generated by any recommendation module. A recommendation module can be any executable file (such as an application) or non-executable file that presents recommendations within a user interface, including the user interface of another application. The recommendations can include advertisements, audio and/or media, software installations, linking to a web site, provision of a web service, or any other type of presentation that can be displayed, viewed or executed on the user device. Also, a recommendation module's user interface can include a notice of recommendation configurability, which can include a notice of the current setting concerning display of recommendations maintained by the recommendation management server and a notice of what commands may be sent to the recommendation management server to configure the receipt of recommendations for display on the user interface of the recommendation module from a recommendation content server.

In numerous embodiments, a history of the commands is recorded within a command history. The command history can be stored in a command history database that is accessible by a recommendation management server accessible by recommendation modules running within a runtime environment of a user device in order to retrieve information concerning recommendation configurability for presentation within the user interface of a recommendation module, such as but not limited to whether the current command status concerning display of recommendations on the recommendation module's user interface is to suspend presentation of recommendations on that particular recommendation module. Recommendation modules can access the command history at any time, such as (but not limited to) during the launch of a recommendation module, prior to the presentation of recommendations in a user interface, during the presentation of recommendations in a user interface, between the presentation of recommendations from different publishers of recommendations or between the presentation of recommendations from different recommendation content servers. In certain embodiments, a command history can include both commands generated by recommendation modules and commands not generated by a recommendation module with the same force as a command generated by a recommendation module.

Recommendation modules can access the command history by querying and retrieving the command history within the command history database utilizing any mechanism for exchanging information between recommendation modules including (but not limited to) an API, function calls, method calls or callback systems. Once retrieved, a user of the recommendation module can then be notified of recommendation configurability in the user interface of the recommendation module, enabling a user to interact with the user interface to further configure the presentation of recommendations.

In certain embodiments, user interactions with the user interface of the user device include interactions with graphics or text that conveys information related to a notice of recommendation configurability. In numerous embodiments, text in a user interface that provides a notice of recommendation configurability can be implemented using native and/or non-natively compiled code. In certain embodiments, text in a user interface that is a notification of recommendation configurability can be implemented as an active text field. Active text fields are regions of a user interface that include malleable text that can change based upon user interaction with the region that includes the active text field. The user interaction with the active text field can include (but is not limited to) a user clicking or hovering a cursor over the region with the active text field to display different text in the active text field. An active text field can be implemented as a Flash recommendation module, which executes within a virtual machine (i.e. a software implementation of a programmable machine) that is capable of playing back or running Small Web Format (SWF) files, a file format specified by Adobe Systems Incorporated of San Jose, Calif. for multimedia, vector graphics, and ActionScripts.

In many embodiments, a user can be presented with a notice of recommendation configurability and the user device can send commands to a recommendation management server in response to user interaction with an active text field of the user device. In several embodiments, a notice of recommendation configurability on a recommendation module's user interface includes a notice of the current command status concerning display of recommendations on the recommendation module's user interface. In certain embodiments, a command can be sent to stop recommendations from being sent to particular recommendation modules running on a user device. A command to stop recommendations from being sent to particular recommendation modules running on a user device includes stemming the transmission of targeted and general recommendations as well as the disabling of downloading, extracting, loading or executing of content from a recommendation content server, such as but not limited to libraries or other software for the support of recommendations that can be displayed in the user interface of a user device.

In several embodiments, recommendations presented using a user configurable recommendation system can be presented in an installer recommendation module that presents recommendations during the installation of other recommendation modules. Various installer recommendation modules can each access a command history database to retrieve information concerning recommendation configurability that is presented within the user interface of the installer recommendation module. In certain embodiments, a recommendation module such as but not limited to an installer recommendation module can access a command history database using a recommendation management server to find the current command status concerning display of recommendations on the installer recommendation module's user interface. In many embodiments, the current command status of the user device may be determined based upon a command sent from another recommendation module currently or previously executing on the user device on which the installer recommendation module is executing. This can be useful to determine if the current command was to send an instruction to a recommendation content server to stop sending recommendations to the installer recommendation module. The installer recommendation module can then display a notice of recommendation configurability informing the user that the installer recommendation module is not receiving recommendations in its user interface based upon that current command status maintained by the recommendation management server. In particular embodiments, an installer recommendation module can be included in an installation package for applying new recommendation modules to a user device that also includes a payload application to be installed in the user device and a payload application installer. Numerous examples of installer recommendation modules that can be utilized with user configurable recommendation systems are discussed in U.S. patent Recommendation module Ser. No. 12/398,136, entitled “Advertising and Promotional System”, filed on Mar. 4, 2009, the disclosure of which is hereby incorporated by reference in its entirety.

Recommendation systems in accordance with embodiments of the invention are discussed further below.

### System Architecture

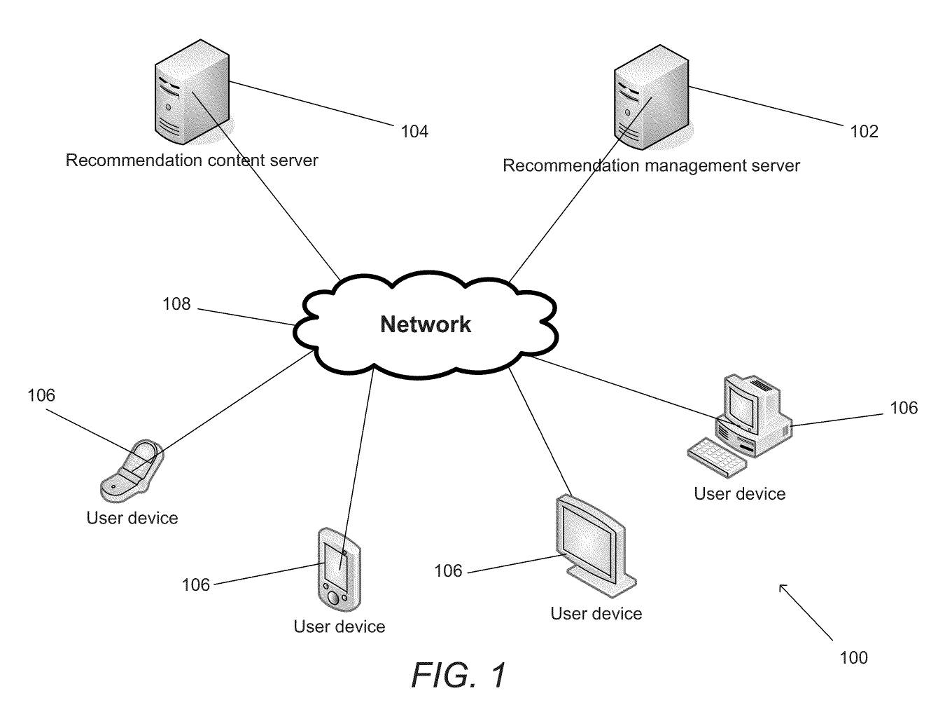

User configurable recommendation systems in accordance with embodiments of the invention enable a recommendation module's user interface to present both recommendations that are generated from recommendation resources received from a recommendation content server as well as an interactive notification of recommendation configurability. In many embodiments, the notification of recommendation configurability includes a notification of the current status concerning display of recommendations on a user interface. A user configurable recommendation system integrating various devices over a network to present recommendations on a recommendation module user interface on a user device in accordance with an embodiment of the invention is illustrated in FIG. 1. The system 100 includes a recommendation manager server 102 and a recommendation content server 104 connected with various user devices 106 over a network 108, such as but not limited to the Internet. In many embodiments, each of the user devices can run recommendation modules with user interfaces that can present recommendations to users. These recommendations are generated from resources that are sent from the recommendation content server over the network to the user devices, where they are received by the recommendation modules running on the user devices and are eventually presented to users via the recommendation modules' user interfaces. In many embodiments, the recommendations can be targeted to particular user devices or particular recommendation modules based upon user interactions with recommendation modules running on a user device. In several embodiments, these recommendations are not targeted and are sent to user devices without requiring any information about the user device.

In various embodiments, a user configurable recommendation system can utilize a command history database to store and retrieve information related to commands that have configured the presentation of recommendations within a user interface of a recommendation module. This information can be stored and retrieved according to metadata associated with the information in the command history database. The database can be any form of relational database system such as (but not limited to) a Structured Query Language (SQL) database or a SQLite database.

In certain embodiments, a recommendation content server can store resources to generate recommendations within a recommendation content database and send the stored recommendation resources to user devices as instructed by a recommendation management server or a recommendation module. In particular embodiments, a recommendation management server can store a command history of commands that have configured the presentation of recommendations within a recommendation module's user interface in a recommendation management database.

In certain embodiments, utilizing commands received by a recommendation module running on a user device and the command history found within the command history database, the recommendation management server can act as an intermediary to translate the commands sent from the user device into instructions that can be provided to a recommendation content server concerning which recommendations to send to which user devices.

In several embodiments, a recommendation module directly implements commands concerning whether recommendations are displayed within the user interface of the recommendation module and can access a command history database stored locally on a user device to determine the current command concerning the recommendation module. In certain embodiments, recommendation module can access a command history database through an integrating application that can integrate multiple different recommendation modules. In this case, an integrating application has access to query and retrieve information from the command history database and the recommendation module can communicate with an integrating application to retrieve the current command concerning whether recommendations are to be presented in a user interface.

Although specific embodiments are recited above, recommendation management systems can be configured in many different ways including (but not limited to) combining the functions of a recommendation content server and a recommendation management server into a single server system and/or where the servers and devices communicate over a local network as opposed to over the Internet in accordance with many embodiments of the invention. Systems and methods for utilizing a command history database in accordance with embodiments of the invention are discussed further below.

### Command History Database

Command history databases in accordance with many embodiments of the invention can be utilized by a user configurable recommendation system to display recommendations based upon commands implemented by recommendation modules on a user device. In certain embodiments, a command history database can store a command history sent to a recommendation management server such that different recommendation modules can access the command history database and determine the current command concerning display of recommendations on that recommendation module's user interface. In particular embodiments, a command history database can store a command history locally on a user device from where a recommendation module can retrieve the current command concerning the display of recommendations on a user device from that recommendation module. In many embodiments, the current command concerns whether recommendations are to be displayed or not to be displayed on the user interface from the recommendation module. A recommendation module can then notify a user of recommendation configurability, including a notification of the commands that can be sent and the current command concerning display of recommendations on the recommendation module's user interface. The recommendation module can also have resources to present recommendations received from a recommendation content server in accordance with the current command concerning display of recommendations on the recommendation module's user interface.

In certain embodiments, a first installer recommendation module can relay a command that is the current command concerning display of recommendations on both the first and second installer recommendation module's user interface into a command history database. A second installer recommendation module can then access the command history database to retrieve information on the current command concerning display of recommendations on the second installer recommendation module's user interface. The second installer recommendation module can then generate a notification of recommendation configurability within the second installer recommendation module's user interface that includes a notification of the current command while receiving resources to present recommendations from the recommendation content server in accordance with that current command without receiving any input from the user interface of the second installer recommendation module.

In numerous embodiments, a command history database can be accessed at any time during the execution of a recommendation module. In certain embodiments, a command history database can be accessed by a recommendation module prior to the display of recommendations within the user interface of the recommendation module. In particular embodiments, a command history database can be accessed by a recommendation module during the display of recommendations in the user interface of the recommendation module to provide real time information as to the current command concerning display of recommendations on the recommendation module's user interface.

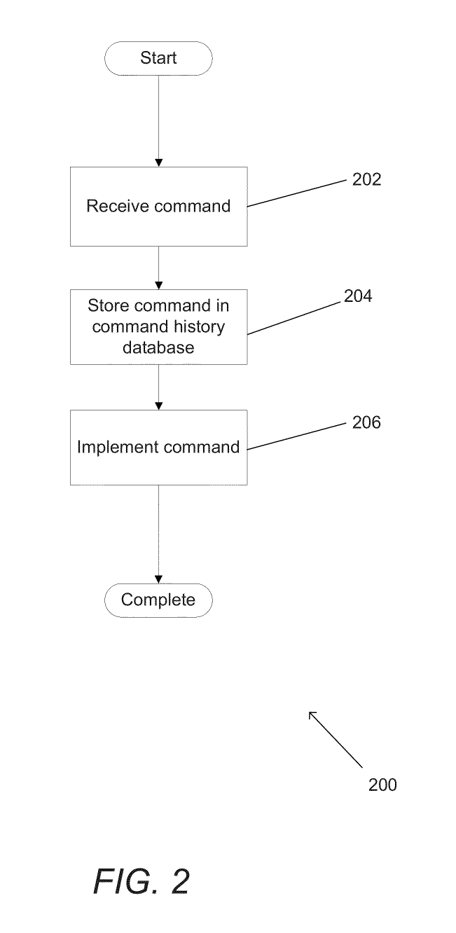

A flow chart that illustrates a process for implementing a command to either present or not present recommendations in a user interface in accordance with an embodiment of the invention is illustrated in FIG. 2. The process 200 includes receiving (202) a command from a user interface concerning whether recommendations are to be displayed by recommendation modules executing with a user device. A record of the command can then be stored (204) in a command history maintained within a command history database. The command history database can be accessible remotely by a recommendation content server or locally by an integrating application that stores the command history database. The command to either present or not present recommendations in a user interface can then be implemented (206). The implementation can occur locally as managed by a recommendation module (such as but not limited to presenting or not presenting recommendations as provided by the recommendation module in a user interface) or remotely by a recommendation management server that sends instructions to send resources a user device that enables recommendation modules to present recommendations.

Although specific configurations of a command history database are discussed above, command history databases can be configured in any manner as appropriate to the requirements of a specific application in accordance with embodiments of the invention.

### Recommendation Module User Interfaces

A user device's user interface can include a notice of recommendation configurability. A notice of recommendation configurability can include any information related to how a user configurable recommendation system can be configured, including the current command concerning display of recommendations on a recommendation module's user interface sent to the recommendation management server and a notification of the commands that can be sent to the recommendation management server. In many embodiments, a notice of recommendation configurability includes the ability for a user to generate commands concerning whether recommendations generated by recommendation modules are to be presented in a user interface of a user device. This can be accomplished by use of an active text field of a user interface that is capable of being changed by a user by clicking on a portion of the active text field. A notice of recommendation configurability can be present within a user interface at any time, including during the installation of an application, upon user device startup or at the presentation of the terms of use for a recommendation module or an application.

In many embodiments, the types of commands that can be sent to the recommendation management server can be presented in accordance with constraints determined locally as stored in a recommendation module or an integrating application or remotely received from a server such as a recommendation content server. In certain embodiments, the types of commands that can be sent to the recommendation management server can be presented in a user interface prior to the presentation of recommendations in the user interface, during the presentation of recommendations in the user interface or during the presentation of only certain recommendations in the user interface.

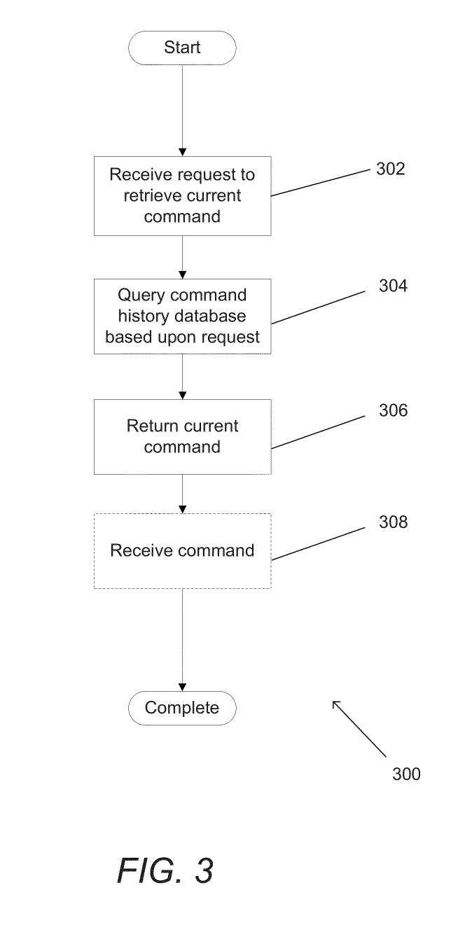

A flowchart of a process of accessing a command history database (by utilizing either a recommendation management server or a recommendation module) for returning a current command concerning display of recommendations on a recommendation module's user interface that causes the recommendation module to update a notice of recommendation configurability in accordance with an embodiment of the invention is illustrated in FIG. 3. The process 300 includes receiving (302) a request from a recommendation module executing on a user device to retrieve the current command concerning display of recommendations on the recommendation module's user interface. The recommendation management server or an integrating application can then query (304) a command history database based upon the request. The recommendation management server or integrating application can then return (306) the current command concerning display of recommendations on the recommendation module's user interface back to the recommendation module that causes the recommendation module to update a notice of recommendation configurability to reflect the current command. The recommendation management server or integrating application can then optionally receive (308) a command from the recommendation module that updates the current command concerning display of recommendations on the recommendation module's user interface.

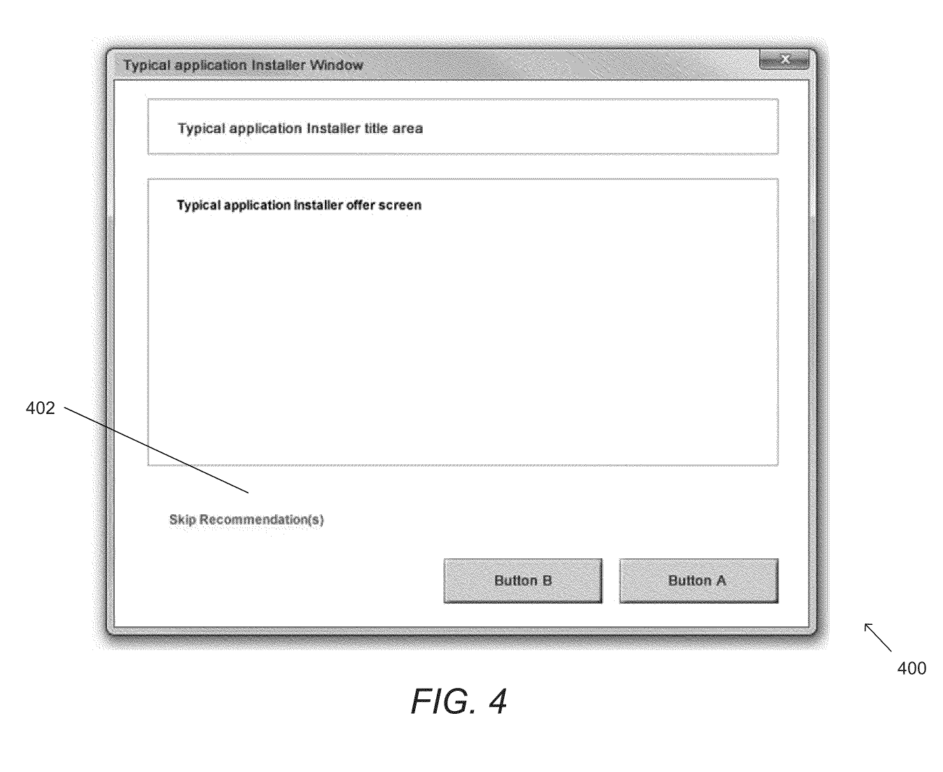

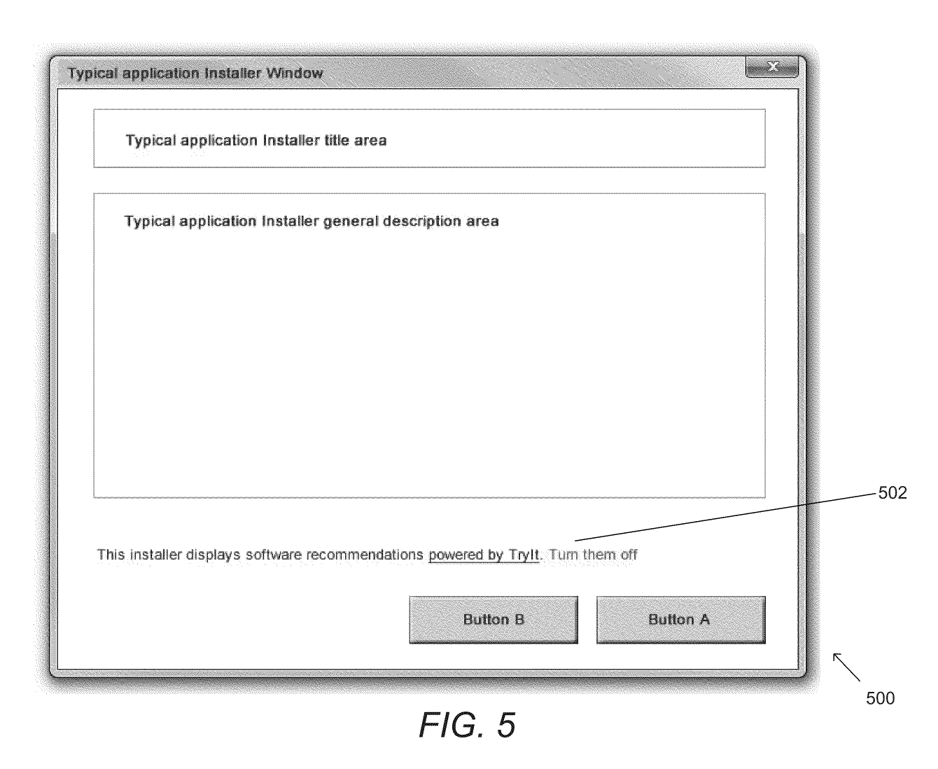

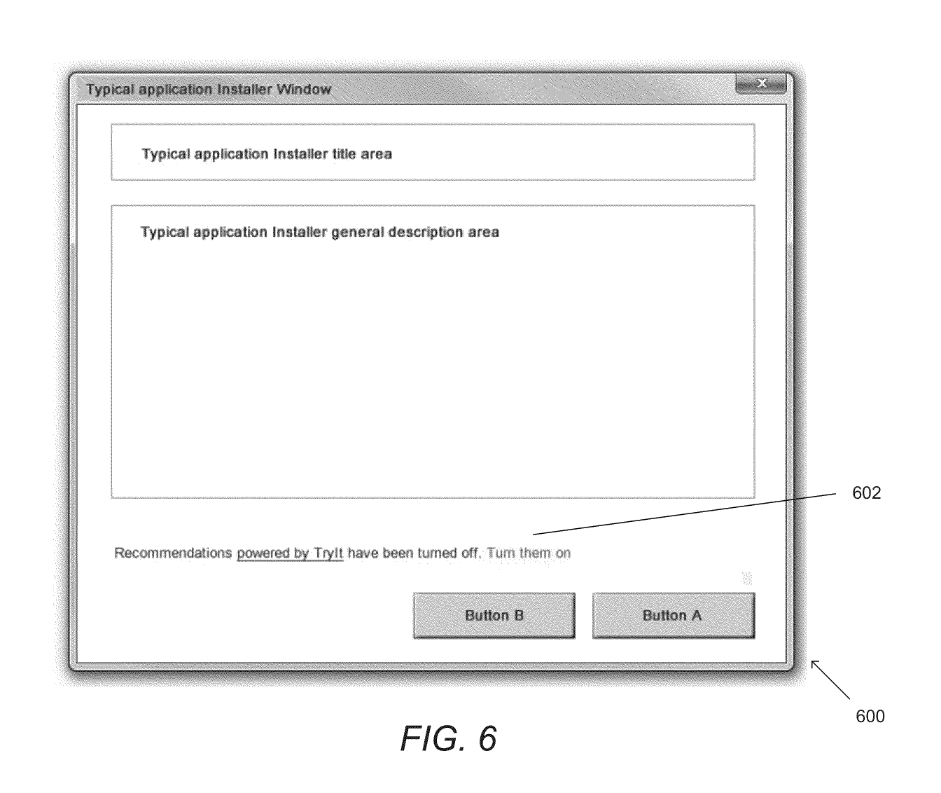

User interfaces presented by recommendation modules in accordance with many embodiments of the invention can display a notice of recommendation configurability in any location and in any way within a user interface of a recommendation module. Screen shots of user interfaces with a presentation of recommendation configurability that enables a user to skip the display of all future recommendations in accordance with an embodiment of the invention is illustrated in FIG. 4. The user interface 400 includes a section that presents recommendation configurability with an active text field that allows a user to skip recommendations by not presenting recommendations by any recommendation module on a user device. A user can generate the command to not have recommendations presented by simply clicking on a portion of the active text field 402. A screen shot of a user interface with an alternate presentation of recommendation configurability that includes a mechanism to generate a command to no longer have recommendations presented in a user interface in accordance with an embodiment of the invention is illustrated in FIG. 5. The user interface 500 includes a section that presents recommendation configurability with an active text field 502 that allows a user to toggle between generating a command concerning whether recommendations are displayed in a user interface from any recommendation module by clicking on the active text field 502 of the recommendation module's user interface. A screen shot of a user interface that enables a user generate a command to have recommendations presented in a user interface in accordance with an embodiment of the invention is illustrated in FIG. 6. The user interface 600 of a recommendation module includes a region that presents recommendation configurability with an active text field 602 that notifies a user that the current command concerning display of recommendations on the recommendation module's user interface was to not have recommendations displayed in the user interface. A user can click on a portion of the active text field 602 to generate a command to present recommendations in the recommendation module's user interface.

Although specific configurations of user interfaces are discussed above, user interfaces can be configured in any manner as appropriate to the requirements of a specific application in accordance with embodiments of the invention. Various types of installer recommendation modules that can be utilized as recommendation modules running on user devices in user configurable recommendation systems are discussed below.

### Installer Recommendation Modules

Recommendation modules in accordance with many embodiments of the invention that can be integrated with user configurable recommendation systems can include installer recommendation modules that are utilized to present offers during the installation of software or other applications. In many embodiments, installer recommendation modules can present recommendations to users during the execution of an installation package. When a user installs an installation package, an installer recommendation module bundled with the installation package communicates with the recommendation management server to coordinate the provision of recommendations to the user. An installation package can be software, firmware, a web recommendation module and/or other form of execution instructions that apply new software or firmware to a user device, update existing software or firmware, perform a service signup, display media, and/or execute a similar operation on a user device. In many embodiments, publishers can publish an installation package and derive revenue from a user configurable recommendation system without the need to develop individual advertising agreements from recommendations with advertisers. In several embodiments, recommendations provided by the user configurable recommendation system to a user via a publisher's installation package are selected to maximize the revenue generated by the publisher. In a number of embodiments, recommendations are selected according to criteria including, but not limited to, the recommendations most likely to be accepted by users of a publisher's installation package, offers a publisher chooses to provide and/or other criteria designed to provide users with useful recommendations and/or generate revenue.

In a number of embodiments, the recommendations provided to a user by the user configurable recommendation system are customized according to information ascertained by the installer recommendation module and/or a recommendation management server concerning the user and/or the user device. In several embodiments, the installer recommendation module tracks offers provided to users and user responses to offers. In many embodiments, the user configurable recommendation system validates installation packages, user devices and/or users so that publishers can supervise the use of the installation packages and so that advertisers are provided with assurances that recommendations are presented to and accepted by legitimate users.

In numerous embodiments, an installation package for applying new software to a user device includes an installer recommendation module that displays recommendations during the installation of a payload application, payload application installer and a payload application, which is a recommendation module to be installed. The payload application installer performs operations that can install the payload application to the user device. In many instances, the payload application installer is specifically written to install a particular payload application contained in the installation package. However, many payload application installers are general-purpose and the installation package includes instructions or scripts that provide directions to the general-purpose payload application installer concerning the manner in which a payload application is to be applied to a user device. Examples of general-purpose payload application installers that can be used to create installer packages for applying new software to a user device include the Nullsoft Scriptable Install System (NSIS) installer distributed by Nullsoft, the InstallShield installer distributed by Acresso Software Inc., the MSI installer distributed by Microsoft Corporation, SetupFactory distributed by Indigo Rose Corporation and the Inno Setup installer developed by Jordan Russell and Martijn Laan and distributed via the website located at http://www.InnoSetup.com. In other embodiments, the installation package updates existing software or firmware, performs a service signup, displays media, and/or executes an operation on the user device.

In numerous embodiments, a user can accept a recommendation after the recommendation is presented in the user interface of a user device. The effect of accepting a recommendation can cause the installer recommendation module to request an additional payload application to fulfill the accepted recommendation from a recommendation content server to be installed in the user device. Additionally, an installer recommendation module can inform a recommendation management server or otherwise make note of the accepted recommendation.

As discussed above, installation packages in accordance with embodiments of the invention can include an installer recommendation module that connects to the user configurable recommendation system and provides offers to a user. The installer recommendation module can be bundled with the installation package, integrated within the payload application installer and/or integrated within a payload application. In many instances, the installer recommendation module is included in the installation package so that the publisher of the installation package can generate revenue by providing offers to users. In several embodiments, publishers can create installation packages that include an installer recommendation module using tools provided by the user configurable recommendation system and a general-purpose payload application installer.

In many scenarios, the same installer recommendation module can be used with a number of different general-purpose payload installers using adaptors. The adaptors are typically written in the scripting language of the payload application installer (although can include executable code). In several embodiments, the installer recommendation module supports a number of APIs that are used by the adapter to interface the payload application installer with the installer recommendation module. An installer recommendation module in accordance with an embodiment of the invention developed for use with one or more variants of the Windows operating system distributed by Microsoft Corporation implements the installer recommendation module as a Dynamic Link Library (DLL) including a number of APIs. In circumstances where an adaptor is not provided to integrate a payload application installer with the installer recommendation module, the payload application installer can be directly integrated with the DLL.

Although specific configurations of installer recommendation modules in a user configurable recommendation system are discussed above, installer recommendation modules can be configured in any manner as appropriate to the requirements of a specific application in accordance with embodiments of the invention. Methods of generating targeted recommendations are discussed below.

### Targeted Recommendations

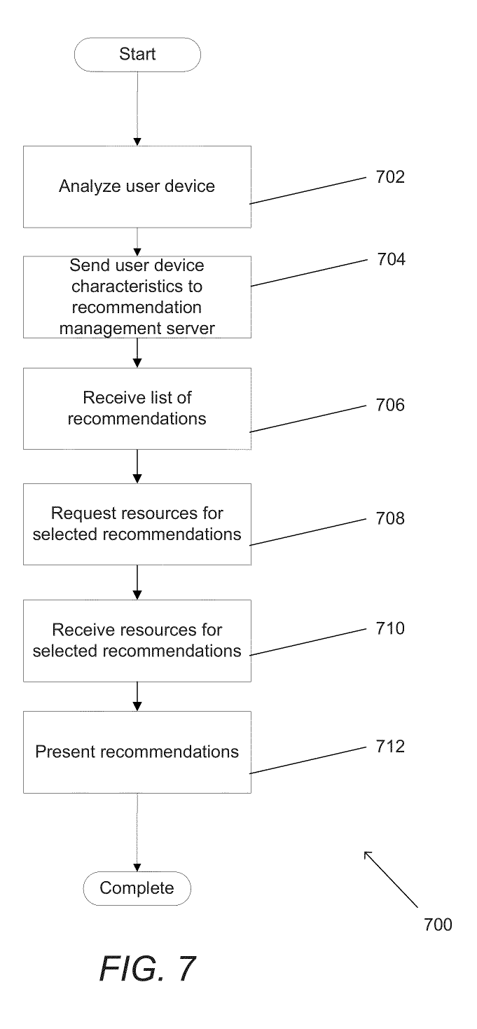

In many embodiments, a recommendation module can present targeted recommendations based upon characteristics of a user device. A process of presenting targeted recommendations utilizing a recommendation module in accordance with an embodiment of the invention is illustrated in FIG. 7. The process 700 includes the recommendation module analyzing (702) the user device for information on user device characteristics. User device characteristics can include any characteristic of a user device including, but not limited to, the language of the text presented in a user interface, the type of operating system on the user device or the common activities of users of the user device. After analyzing (702) the user device for information on user device characteristics, the recommendation module can send (704) the information on user device characteristics to a recommendation management server. The recommendation module can then receive (706) a list of recommendations according to the information on user device characteristics. The recommendation module can then select particular recommendations to be presented in a user interface by the recommendation module from the list of recommendations and request (708) the resources necessary to present the particular recommendations from a recommendation content server. Upon receiving (710) the resources, the recommendation module can then present (712) the particular recommendations in the user interface.

Although specific configurations of recommendation modules that can generate targeted recommendations in a user configurable recommendation system are discussed above, recommendation modules can be configured in any manner as appropriate to the requirements of a specific application in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, including various changes in the implementation such as utilizing multimedia frameworks that support features beyond those described above, without departing from the scope and spirit of the present invention. Thus, embodiments of the present invention should be considered in all respects as illustrative and not restrictive.

What is claimed is:

1. A user configurable recommendation system comprising:
at least one recommendation module running on a user device configured to present recommendations in a user interface of a user device based upon at least one command generated by at least one recommendation module;
a command history database accessible by at least one recommendation module and configured to store a history of commands generated by at least one recommendation module;
wherein at least one recommendation module is a requesting recommendation module configured to:
send a request to query the command history database for information on a current command concerning display of recommendations on the requesting recommendation module's user interface; and
receive the information on the current command concerning display of recommendations on the requesting recommendation module's user interface that causes the requesting recommendation module to present a notification of the current command along with a notification of commands that may be generated in the user interface of the requesting recommendation module.

2. The user configurable recommendation system of claim 1, wherein the command history database is accessible through an integrating application that communicates with at least one recommendation module.

3. The user configurable recommendation system of claim 1, wherein each command concerns whether recommendations are to be presented by the requesting recommendation module in the user interface of the user device.

4. The user configurable recommendation system of claim 1, wherein the requesting recommendation module presents a notification of the current command along with a notification of commands that may be generated as text displayed in the user interface by requesting recommendation module.

5. The user configurable recommendation system of claim 3, wherein the text is displayed as an active text field.

6. The user configurable recommendation system of claim 4, wherein the active text field is implemented as a Flash application that is capable of running Small Web Format files.

7. The user configurable recommendation system of claim 5, wherein the requesting recommendation module presents a notification of the current command along with a notification of commands that may be generated graphically as a picture displayed in the user interface of the requesting recommendation module.

8. The user configurable recommendation system of claim 1, wherein:
the user device is configured to execute an installation package comprising a payload application installer, a payload application and the requesting recommendation module, where the execution of the installation package causes the payload application to be installed on the user device and triggers execution of the requesting recommendation module, which is configured to automatically collect information stored on the user device during the installation of the payload application and to forward the collected information to a recommendation management server as the installation package performs the installation of the payload application;
the recommendation management server is configured to send a list of recommendations to the requesting recommendation module, where the recommendation management server selects the recommendations to include in the list of recommendations based upon the information collected during the installation of the payload application that configures the requesting recommendation module to select recommendations from the list of recommendations and request resources for the recommendation module to present the selected recommendations in a user interface of the user device from a recommendation content server; and
the requesting recommendation module is configured to display the particular recommendations from resources received from the recommendation content server during the installation of the payload application.

9. The user configurable recommendation system of claim 8, wherein the requesting recommendation module is bundled in the installation package and the payload application installer activates the requesting recommendation module via an adaptor.

10. The user configurable recommendation system of claim 8, wherein the recommendation content server and the recommendation management server are consolidated within a single server.

11. A method of managing recommendations in a user configurable recommendation management system comprising at least one recommendation module running on a user device configured to present recommendations in a user interface of a user device based upon at least one command generated by at least one recommendation module, comprising:
sending a request using a requesting recommendation module to query a command history database for information on a current command concerning display of recommendations on a requesting recommendation module's user interface, wherein:
the command history database is accessible by at least one recommendation module and configured to store a history of commands generated by at least one recommendation module; and
at least one recommendation is the requesting recommendation module; and
receiving the information on the current command concerning display of recommendations on the requesting recommendation module's user interface using the requesting recommendation module that causes the requesting recommendation module to present a notification of the current command along with a notification of commands that may be generated in the user interface of the requesting recommendation module.

12. The method of claim 11, wherein the command history database is accessible through an integrating application that communicates with at least one recommendation module.

13. The method of claim 11, wherein each command concerns whether recommendations are to be presented by the requesting recommendation module in the user interface of the user device.

14. The method of claim 11, wherein the requesting recommendation module presents a notification of the current command along with a notification of commands that may be generated as text displayed in the user interface by requesting recommendation module.

15. The method of claim 13, wherein the text is displayed as an active text field.

16. The method of claim 14, wherein the active text field is implemented as a Flash application that is capable of running Small Web Format files.

17. The method of claim 15, wherein the requesting recommendation module presents a notification of the current command along with a notification of commands that may be generated graphically as a picture displayed in the user interface of the requesting recommendation module.

18. The method of claim 11, wherein:
the user device is configured to execute an installation package comprising a payload application installer, a payload application and the requesting recommendation module, where the execution of the installation package causes the payload application to be installed on the user device and triggers execution of the requesting recommendation module, which is configured to automatically collect information stored on the user device during the installation of the payload application and to forward the collected information to a recommendation management server as the installation package performs the installation of the payload application;
the recommendation management server is configured to send a list of recommendations to the requesting recommendation module, where the recommendation management server selects the recommendations to include in the list of recommendations based upon the information collected during the installation of the payload application that configures the requesting recommendation module to select recommendations from the list of recommendations and request resources for the recommendation module to present the selected recommendations in a user interface of the user device from a recommendation content server; and
the requesting recommendation module is configured to display the particular recommendations from resources received from the recommendation content server during the installation of the payload application.

19. The method of claim 18, wherein the requesting recommendation module is bundled in the installation package and the payload application installer activates the requesting recommendation module via an adaptor.

20. A user configurable recommendation system comprising:
a recommendation management server configured to send instructions to a recommendation content server that manages recommendations sent from a recommendation content server to a user device for presentation in a user interface of at least one recommendation module running on the user device based upon at least one command sent from at least one recommendation module to the recommendation management server;
a command history database accessible by the recommendation management server and configured to store a history of commands received by the recommendation management server;
wherein the recommendation management server is configured to:
receive a request from a requesting recommendation module that causes the recommendation management server to query the command history database for information on a current command concerning display of recommendations on the requesting recommendation module's user interface sent from the requesting recommendation module to the recommendation management server; and
return the information on the current command concerning display of recommendations on requesting recommendation module's user interface to the requesting recommendation module that causes the requesting recommendation module to present a notification of the current command along with a notification of commands that may be sent to the recommendation management server in the user interface of the requesting recommendation module.
